(19) United States
(12) Patent Application Publication
(10) Pub. No.: US 2005/0005985 A1
(43) Pub. Date: Jan. 13, 2005

(54) Underdrainage pipe

(76) Inventors: Hiroyuki Masui, Osaka-shi (JP); Shoji Hirao, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/884,950

(22) Filed: Jul. 7, 2004

(30) Foreign Application Priority Data
Jul. 7, 2003 (JP) 2003-271356

(51) Int. Cl. F16L 1/00

(52) U.S. Cl. 138/105; 138/130; 138/129; 138/123

(57) ABSTRACT

The underdrainage pipe includes an inner layer 1 formed by helically winding strands 2, 3, and an outer layer 4 also formed by helically winding a strand 5. In the strand 5 in one of the inner and outer layers 1, 4, for example, the outer layer 4, turning sections 9, 9 adjacent to each other in the axial direction of the pipe are fused together in the circumferential direction or in a plurality of positions in the circumferential direction. In these fused portions, the turning sections are further fused to the strand 2 in the other layer, i.e. the inner layer, and at least three strands 2, 5, 5 are thereby fused in one body. The pressure resisting strength of the pipe is thus improved.

### BACKGROUND OF THE INVENTION

1. Field of the Invention

This invention relates to an underdrainage pipe. It is conceivable that the present invention can be used as various kinds of drainage pipes, for example, a drainage pipe buried in a water permeable pavement and adapted to drain the rainwater entering an inner portion thereof, and as a drainage pipe buried in the earth.

2. Description of the Related Art

Among the drainage pipes for underdrainage, a drainage pipe used for a water permeable pavement is buried in a water permeable pavement layer of a thickness of around 5 cm laid on a non-water-permeable pavement layer. Since the drainage pipe is necessary to be buried in a pavement portion of comparatively not so large a thickness, a drainage pipe of a large outer diameter cannot be used. In the meantime, the drainage pipe needs to have an inner diameter large enough to secure a required displacement. The drainage pipe also needs to have a flexibility. In view of these facts, a reticulate underdrainage pipe made of strands of a synthetic resin has recently come to be used.

FIG. 7 shows a related art underdrainage pipe made of such reticulately arranged strands of a synthetic resin. This related art underdrainage pipe includes an inner layer 22 formed by helically winding a plurality of pieces of strands 21 of a synthetic resin in the axial direction of the pipe with a suitable clearance left therebetween, and an outer layer 24 also formed by helically winding a plurality of pieces of strands 23 of a synthetic resin in such an axial direction of the pipe that is opposite to the direction in which the strands 21 in the inner layer 22 are wound with clearances the width of which is equal to that of the clearances between the strands in the inner layer 22 left therebetween. These inner and outer layers 22, 24 are fused together in a body at intersection portions of the strands 21, 23, and a plurality of water passing portions extending through a pipe wall are thereby formed reticulately.

FIG. 8 shows an underdrainage pipe in which the width of the clearances, which extend in the axial direction of the pipe, between strands 23, 23 in an outer layer 24 is increased with respect to the related art example of FIG. 7, to thereby give a higher flexibility to the pipe.

With respect to such a reticulate underdrainage pipe of a double structure described above, Japanese Patent Laid-Open Number 1982-24715 (Patent Document 1) discloses an underdrainage pipe of a substantially triple structure formed by fusing a plurality of thin threads of a synthetic resin extending axially on an outer side of an outer layer thereof. Also, Japanese Utility Model Laid-Open Number 1984-183918 (Patent Document 2) discloses a triple structure formed by providing an outer side of a reticulate pipe with other strand of a synthetic resin around an outer side of a reticulate pipe.

### SUMMARY OF THE INVENTION

A drainage pipe for underdrainage buried in a water permeable pavement and in the earth demands a pressure resistance high enough to withstand a side pressure, such as earth pressure in addition to a sufficient water permeability. Especially, when an outer diameter of an under drainage pipe used for a water permeable pavement as mentioned above is set large correspondingly to an inner diameter thereof which is increased so that a sufficient discharging quantity can be secured, the thickness of a water permeable pavement layer in a portion in which the drainage pipe is buried decreases to cause cracks to readily occur. Therefore, it becomes important to obtain a strength high enough to secure a pressure resistance of the drainage pipe even when the wall thickness thereof is reduced as much as possible so that the outer diameter thereof does not become large even when the inner diameter thereof is increased. As described above, the drainage pipe becomes necessary to have a flexibility high enough for the same pipe to be buried in a bent state in a bent underdrainage and the like.

However, concerning the related art underdrainage pipes, the drainage pipe of FIG. 7 is formed by winding a plurality of strands 21, 23 with equal and narrow clearances left between each thereof in the inner and outer layers 22, 24, and fusing the strands 21, 23 together. This underdrainage pipe is excellent in pressure resistance but inferior in flexibility, so that it is difficult to install this pipe as it is bent. In the underdrainage pipe of FIG. 8, the clearance between the strands 23, 23 in the outer layer 24 is set large so that the pipe has a flexibility. However, the number of the fused portions between the inner and outer layers 22, 23 decreases, and the pressure resistance of the pipe decreases.

All of the underdrainage pipes disclosed in the Patent Documents 1 and 2, a substantially triple layer structure is formed by providing a third strand on the outer side of the reticulate double pipe. Therefore, the pressure resistance of the pipe is high but the flexibility thereof is not taken into consideration at all. In addition, since the pipe has a triple layer structure, the wall thickness becomes large. In addition, in order to secure an inner diameter of the pipe, the outer diameter thereof becomes large as well, so that the pipe cannot be said to be satisfactory as a pipe to be buried in the above-mentioned water permeable pavement.

The present invention has been made for the purpose of eliminating these drawbacks seen in such related art underdrainage pipes, and providing an underdrainage pipe having a sufficient pressure resisting strength, and excellent in flexibility as well.

To solve the above-mentioned problems, the present invention provides, a substantially reticulate underdrainage pipe including an inner layer formed by helically winding one or a plurality of strands, and an outer layer formed also by helically winding one or a plurality of strands, the strands in the inner and outer layers being fused together at parts or over the whole thereof, wherein the strands in the turning sections adjacent to each other in the axial direction of the pipe in either one of the inner and outer layers and parts or the whole of the strand in the other layer are fused together in a plurality of circumferential portions viewed from a pipe end with clearances left therebetween.

In this underdrainage pipe, the fused portions are provided in the range thereof which has a predetermined circumferential length, the pressure resisting strength of the pipe being thereby able to be increased.

In the same underdrainage pipe, it is conceived that the fused portions of the strands adjacent to each other in the axial direction of the pipe are formed by bulging the strands in the axial direction thereof and superposing the resultant strands on each other, or by providing the fused portions on engaged sections thereof.

In the same underdrainage pipe, the fused portions of the strands adjacent to each other in the axial direction of the pipe are provided in three circumferential sections viewed from a pipe end, and desirably at substantially regular intervals, a structure withstanding a side pressure applied thereto in any direction (including a vertical direction) being thereby obtained.

In the same underdrainage pipe, the fusing of the turning sections adjacent to each other in the axial direction of the pipe is done in the outer layer.

In this specification, the turning section is used as a word indicating a unit portion corresponding to one pitch of a helically wound strand.

In the same underdrainage pipe, it is conceived that there are a drainage pipe adapted to suck drainage from an outer circumference of a water passing portion of a pipe wall and discharge the drainage from a pipe end, and a drainage pipe adapted to suck drainage from a pipe end and discharge the drainage through a water passing portion of a pipe wall.

In the same underdrainage pipe, the drainage pipe is basically made of a synthetic resin, using some other raw material being also conceivable as long as the material can be subjected to fusion (which may be called welding).

In the same underdrainage pipe, a cross-sectional shape of the drainage pipe is not only a circular shape but also square or other polygonal shapes.

According to the present invention, a strand fused portion has at least three strands fused in one body, and this portion becomes a strength-carrying member, so that an underdrainage pipe of a high buckling strength is obtained. On the other hand, the other portions not constituting strength-carrying members can be made so as to have a flexibility. Moreover, the area of each region can be increased. As a result, the improvement of the flexibility of the drainage pipe and buckling resistance thereof, and the compatibility of the flexibility thereof with the buckling resistance thereof can be attained far better than those of the related art drainage pipes shown in FIG. 7 and FIG. 8, i.e. drainage pipes in which a region of a small area assuming the strength and that of a region of a small area assuming the flexibility are scattered. Therefore, the portions of the drainage pipe which do not necessarily constitute such strength-carrying members as mentioned above can be given a flexibility, so that a drainage pipe having an excellent flexibility is obtained.

When a plurality of portions constituting the strength-carrying members, desirably not smaller than three such portions viewed from a pipe end are provided in a spaced manner in the circumferential direction, an underdrainage pipe having a very high pressure resistance as compared with a related art underdrainage pipe including inner and outer layers formed by helically winding strands is obtained.

Furthermore, the fused portions may not be formed densely in the axial direction of the pipe. For example, when the strands are fused together as the strands are bulged in the axial direction of the pipe as in a mode of embodiment, the fused portions can be provided with certain size of clearances left in the axial direction of the pipe. Therefore, an underdrainage pipe in which the parts of the strands which are between the fused portions can be bent flexibly and easily with a sufficient water permeability secured. Owing to this structure, the present invention could provide an underdrainage pipe having both a high flexibility and a high pressure resistance.

Furthermore, according to the present invention, it is unnecessary unlike the related art underdrainage pipe that the pipe be reinforced by providing a third layer on an outer side of the inner and outer layers. Therefore, the outer diameter of the pipe can be set as small as possible with a sufficiently large inner diameter secured, and this underdrainage pipe is optimum as a pipe to be buried in a water permeable pavement.

### BRIEF DESCRIPTION OF THE DRAWINGS

Preferred modes of embodiments of the present invention will now be described with reference to the accompanying drawings, wherein:

FIG. 1 is a front view of an underdrainage pipe in a mode of embodiment of the present invention;

FIG. 2 is a longitudinal sectional view of the same underdrainage pipe in the mode of embodiment of the present invention;

FIG. 3 is an enlarged view of a principal portion of what is shown in FIG. 2;

FIG. 4 is a perspective view of a principal portion of an outer layer;

FIG. 5 is an enlarged longitudinal sectional view showing a principal portion of another mode of embodiment of the present invention;

FIG. 6 is a front view of an underdrainage pipe in another mode of embodiment of the present invention;

FIG. 7 is a front view of a related art underdrainage pipe; and

FIG. 8 is a front view of another related art underdrainage pipe.

### DETAILED DESCRIPTION OF THE INVENTION

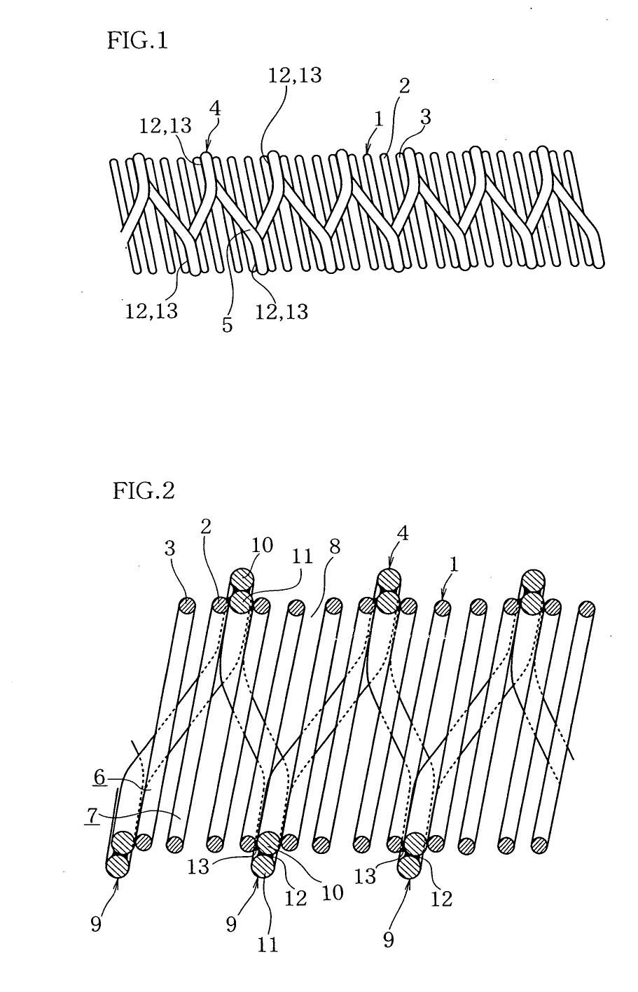

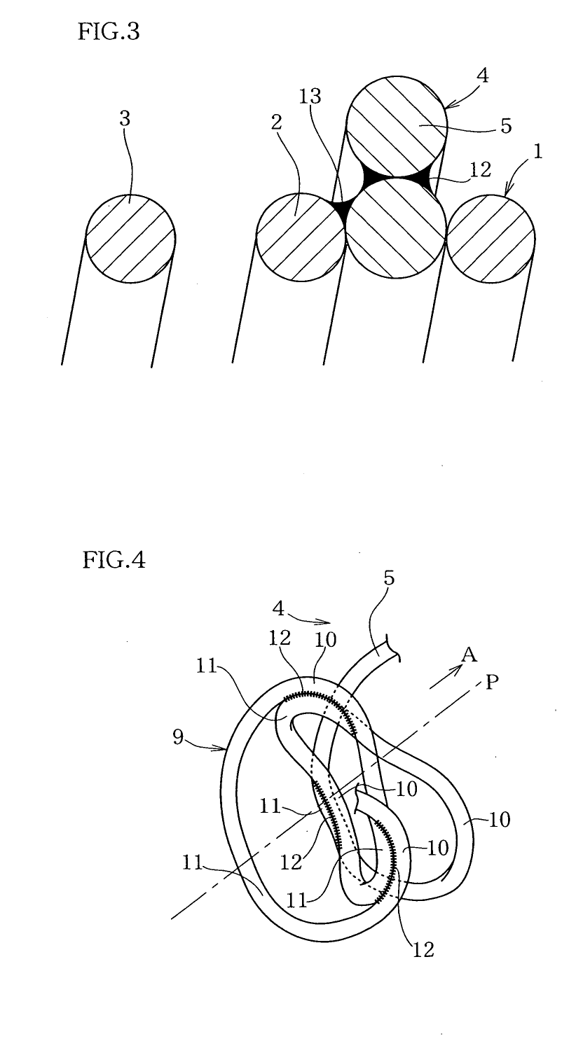

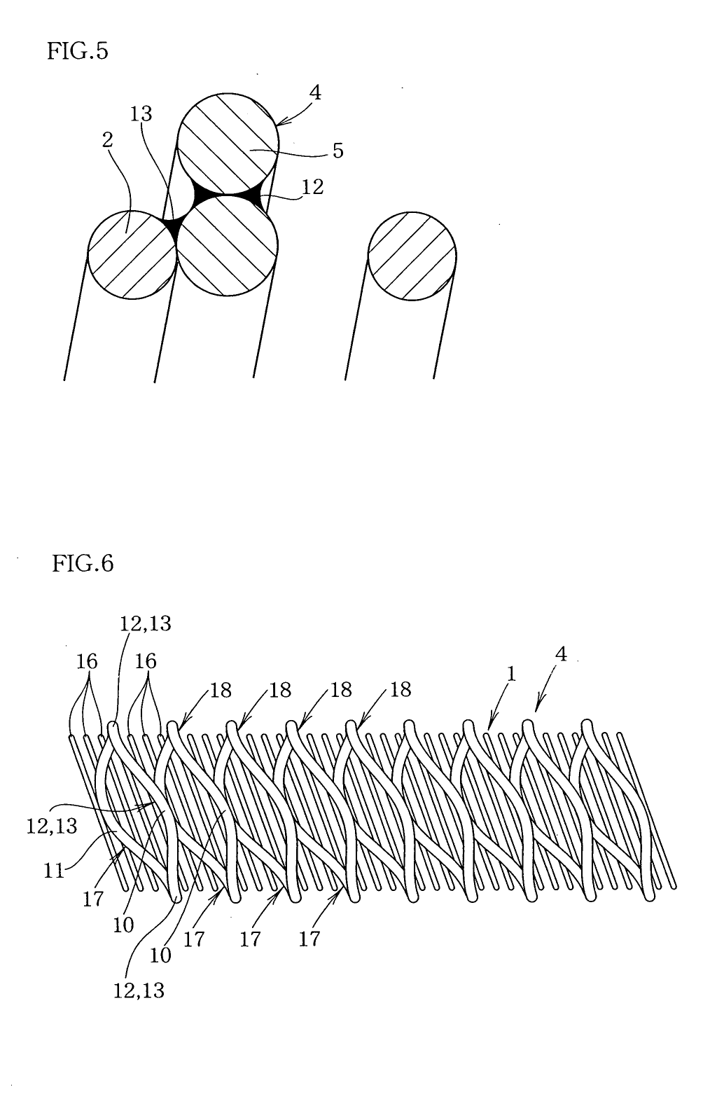

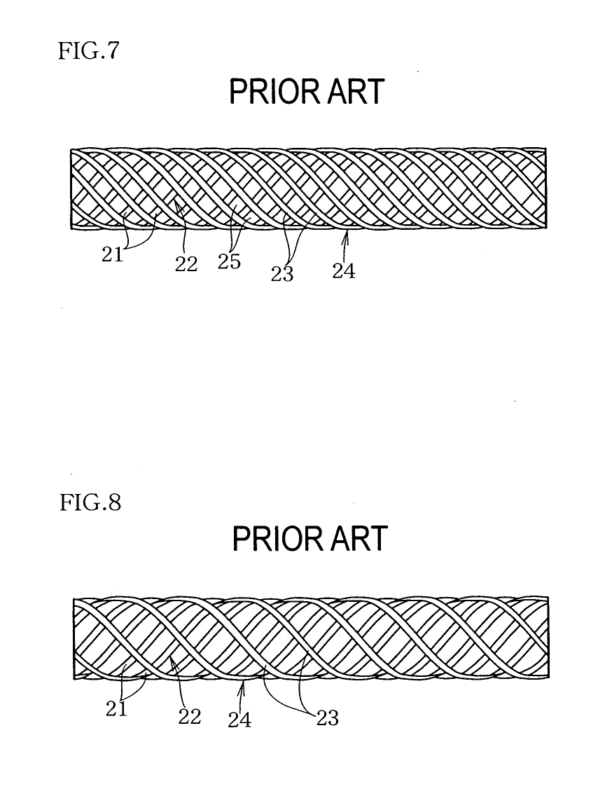

FIGS. 1 to 4 show one mode of embodiment of the present invention. Referring to the drawings, a reference numeral 1 denotes an inner layer including one or a plurality of pieces, to be concrete, two pieces of strands 2, 3, and 4 an outer layer including one or a plurality of pieces, to be concrete, one strand 5.

The two pieces of strands 2, 3 constituting the inner layer 1, are wound helically so as to be inclined in the same diagonal direction, according to that both said pieces of strands 2,3 are arranged with the regular intervals and that their turning sections 6,7 passes alternately in the axial direction. Consequently a tubular body with a helical clearance 8 of a suitable width between the turning sections 6,7 is formed.

The strands 2, 3 are, for example, cross-sectionally circular solid parts as shown in the drawings, and usually formed out of a hard synthetic resin, such as polyethylene resin and some other synthetic resin.

The strand 5 forming the outer layer 4 is also wound helically along an outer circumference of the inner layer 1. During this time, the clearances between turning sections 9, 9 . . . are set larger than those between the turning sections in the inner layer 1. This helix is partially bent or curved forward or rearward in the axial direction P with respect to a normal helical curve as shown in FIG. 4, and bulging portions 10, 11 . . . extending in the axial direction of a pipe are formed in every turning section 9, which corresponds to one pitch, in three circumferential positions viewed from a pipe end, at regular intervals.

These bulging portions 10, 11 are divided into forwardly (in the direction of an arrow A in FIG. 4) bulging portions 10 with respect to a winding direction and rearwardly bulging portions 11 with respect to the same. The bulging portions 10, 11 are formed so that the circumferential positions thereof in each turning section 9 agree with each other with the bulging directions thereof in every turning section 9 change alternately. The bulging portions 10, 11 opposed to each other in the axial direction of the pipe are superposed on each other in the diametrical direction of the pipe, and fused 12, 12 to each other in a certain range of length in the circumferential direction. Furthermore, in these fused portions 12, 12 . . . , the strand 5 in the outer layer 4 and one strand 2 in the inner layer 1 are engaged with each other in the axial direction P of the pipe and fused 13, 13 to each other over the ranges of the same length.

In these fused portions 12, 13, three strands, i.e. a pair of strands 5, 5 in the turning sections 9, 9 adjacent to each other in the outer layer 4 and one strand 2 in the inner layer 1 are fused together in one body, so that the buckling strength of the pipe in the diametrical direction of the pipe comes to be very high. Thus, the portions constituting a strength member for securing the pressure resistance are reinforced by uniting the three strands 5, 5, 2 in the inner and outer layers together. This enables the other portions for securing the flexibility of the pipe to become sufficiently high, and the pressure resistance and flexibility are given to the pipe. When these fused portions 12, 13 are turned in the helical direction as the fused portions are bent or curved forward or rearward in the axial direction of the pipe with respect to a normal helical curve as described above, the fused portions 12, 13 of the turning sections 9 existing in the same positions on the circumference are separated from each other in the axial direction of the pipe to cause hard portions of the pipe to be distributed coarsely. A sufficient water permeability is thus secured in the inward and outward directions of the pipe, and the pipe is thereby rendered easily bendable.

In the above described embodiment, the buckling strength in the diametrical direction of the pipe is rendered higher by desirably fusing the strands in a certain range of the length thereof in the circumferential direction thereof. In this case, it is conceivable that the more vertical or the closer to a vertical line in side elevation view the strands 2,5 in the fused portions 12,13 are designed, the higher the buckling strength in the diametrical direction of the pipe becomes, for example, FIG. 1.

To be concrete, the length of the fused portions 12, 13 in this mode of embodiment is around ⅓ of that of the strand 5 corresponding to one pitch thereof. As a result, the same around ⅓ non-fused portions are left between the fused portions 12, 12. The bending property of the fused portion 12 is extremely restricted, whereas the non-fused portions can be bent flexibly.

The setting of the length of the fused portions 12, 13 are designed according to the balance between the flexibility and the buckling strength of the pipe. Therefore, the strands may only be spot-fused as long as a sufficient strength of the pipe is obtained.

In this mode of embodiment, the strand 3 in the inner layer 1 which is not fused to the strand 5 in the outer layer 4 is not fused to other strand 2 but in a free state. Of course, the strand 3 may be fused to both or one of the other strands 5, 2. The clearance 8 between the turning sections 6, 7 in the inner layer 1 is defined by the strand 5 in the outer layer 4 as mentioned above, and an underdrainage pipe provided with a plurality of mesh type water passing portions 14, 14 is thereby formed.

In this mode of embodiment described above, adjacent turning sections 9, 9 of the strand 5 in the outer layer 4 are superposed on each other in the diametrical direction and fused together, and these turning sections may also be superposed on each other in the axial direction of the pipe and fused together. The adjacent turning sections of the strands 2, 3 in the inner layer 1 instead of such sections in the outer layer 4 may also be fused in the same manner, if possible. Furthermore, the fused portions 12, 13 are provided in three positions in the circumferential direction (circumferential direction or outer circumferential direction of a cross section) viewed from a pipe end. These fused portions may also be provided in two positions or not smaller than four positions.

In the above mode of embodiment, the outer layer 4 has one piece of strand 5 but the same effect is obtained when not smaller than two pieces of strands 5 are provided. When one piece of strand 5 is provided as shown in the above mode of embodiment, the adjacent turning sections 9, 9 are parts of the same strand 5. When a plurality of pieces of strands are provided, turning sections 9 of different strands 5 adjoin each other, and the turning sections 9 of these different strands 5 are fused together only.

When four pieces of strands 5 are provided, for example, a second strand adjoins turning sections of a first strand and a third strand, so that the second strand turns in the circumferential direction as the second strand is fused to the first strand and third strand alternately. The third strand and fourth strand are turned in the circumferential direction as the third and fourth strands are fused to the second and fourth strands and the third and first strands alternately respectively. Furthermore, in the position of fusion of the turning sections in the outer layer 4, the strands in this layer are also fused to those in the inner layer 1.

On the other hand, the inner layer has two pieces of strands 2, 3. The number of these strands can also be set to one or not smaller than three.

FIG. 6 shows an another mode of embodiment of this invention when the number of the strands forming the inner layer 1 are set to not smaller than three and the outer layer 4 has the plurality of pieces of strands. In this embodiment, the number of strands 16 forming the inner layer 1 is ten and the outer layer 4 has the four pieces of strands 17,18.

According to the present invention, ten pieces of strands 16 are wound helically at the regular intervals.

The first two pieces of strands 17 forming the outer layer 4 are wound helically along the outer circumference of the inner layer 1 and their helixes are bent or curved forward or rearward in the same axial direction. The second two pieces of strands 18 forming the same outer layer 4 are also wound helically and the helixes of these strands 18 are bent or curved to the reverse direction of the first two pieces of strands 17. The forwardly bulging portion 10 of the first strands 17 and rearwardly bulging portion 11 of the second strands 18 are fused to each other. On the other hand, the rearwardly bulging portion 11 of the first strands 17 and the forwardly bulging portion 10 of the second strands 18 are fused 12 to each other. At least one strand 16 of the inner layer is fused 13 to the strand 17 or 18 in the fused position 12.

The present invention can be utilized as a drainage pipe buried in a water permeable pavement referred to in the modes of embodiments, and, besides this, as various kinds of drainage pipes buried in the earth.

1. A substantially reticulate underdrainage pipe comprising an inner layer formed by one or a plurality of helically winding strands, and an outer layer formed also by helically winding one or a plurality of strands, the strands in the inner and outer layers being fused together at parts or over the whole thereof,
the strands in the turning sections adjacent to each other in the axial direction of the pipe in either one of the inner and outer layers and parts or the whole of the strands in the other layer being fused together in a plurality of circumferential positions viewed from a pipe end with clearances left therebetween.

2. An underdrainage pipe according to claim 1, wherein the fused portions are provided over a certain circumferential length thereof.

3. An underdrainage pipe according to claim 1, wherein the fused portions of the strands adjacent to each other in the axial direction of the pipe are formed by bulging the strands in the axial direction of the pipe and superposing the resultant strands on each other, or by providing the fused portions on engaged sections.

4. An underdrainage pipe according to claim 2, wherein the fused portions of the strands adjacent to each other in the axial direction of the pipe are provided by bulging the strands in the axial direction of the pipe and superposing the strands on each other, or on engaged portions thereof.

5. An underdrainage pipe according to claim 1, wherein the fused portions of the strands adjacent to each other in the axial direction of the pipe are provided in a substantially equally spaced manner in three positions in the circumferential direction viewed from a pipe end.

6. An underdrainage pipe according to claim 2, wherein the fused portions of the strands adjacent to each other in the axial direction of the pipe are provided in a substantially equally spaced manner in three positions in the circumferential direction viewed from a pipe end.

7. An underdrainage pipe according to claim 3, wherein the fused portions of the strands adjacent to each other in the axial direction of the pipe are provided in a substantially equally spaced manner in three positions in the circumferential direction viewed from a pipe end.

8. An underdrainage pipe according to claim 4, wherein the fused portions of the strands adjacent to each other in the axial direction of the pipe are provided in a substantially equally spaced manner in three positions in the circumferential direction viewed from a pipe end.

9. An underdrainage pipe according to claim 1, wherein the fused portions of the turning sections adjacent to each other in the axial direction of the pipe are provided in the outer layer.

10. An underdrainage pipe according to claim 2, wherein the fused portions of the turning portions adjacent to each other in the axial direction of the pipe are provided in the outer layer.

11. An underdrainage pipe according to claim 3, wherein the fused portions of the turning sections adjacent to each other in the axial direction of the pipe are provided in the outer layer.

12. An underdrainage pipe according to claim 4, wherein the fused portions of the turning sections adjacent to each other in the axial direction of the pipe are provided in the outer layer.

13. An underdrainage pipe according to claim 5, wherein the fused portions of the turning sections adjacent to each other in the axial direction of the pipe are provided in the outer layer.

14. An underdrainage pipe according to claim 6, wherein the fused portions of the turning sections adjacent to each other in the axial direction of the pipe are provided in the outer layer.

15. An underdrainage pipe according to claim 7, wherein the fused portions of the turning sections adjacent to each other in the axial direction of the pipe are provided in the outer layer.

16. An underdrainage pipe according to claim 8, wherein
the fused portions of the turning sections adjacent to each other in the axial direction of the pipe are provided in the outer layer.
